(19) United States
(12) Patent Application Publication
(10) Pub. No.: US 2009/0298003 A1
(43) Pub. Date: Dec. 3, 2009

(54) Self-Ligating Orthodontic Bracket

(76) Inventors: Yu-chen Wei, Yuanlin Township (TW); Chih-chang Tsai, Kaohsiung City (TW)

Correspondence Address: TROXELL LAW OFFICE PLLC, SUITE 1404, 5205 LEESBURG PIKE, FALLS CHURCH, VA, 22041, US

(21) Appl. No.: 12/128,374

(22) Filed: May 28, 2008

(51) Int. Cl. A61C 7/16

(52) U.S. Cl. 433/9

(57) ABSTRACT

A self-ligating orthodontic bracket, comprising a main body provided with a slot at one end of the top thereof for placing an arch wire therein and a base fixed to the bottom of the main body, is adhered to the outer surface of a tooth via the bottom of the base and is characterized in that: the main body is detachably connected with a cover, where the main body comprises a connecting part and at least an engaging part. The connecting part is located at one end near the slot and is provided with at least a track at two lateral sides respectively. The engaging part is provided at one end of the connecting part. The cover has two lateral sides that are in sliding connection with the tracks and is provided with at least a protrusion on its bottom for engagement with the engaging part. Thereby, the cover can be open or closed conveniently for users to place an arch wire into the slot or remove the arch wire out of the slot.

### BACKGROUND OF THE INVENTION

1. Field of the Invention

The present invention relates to an orthodontic bracket and, more particularly, to a self-ligating orthodontic bracket, which is pleasing in appearance and easy to operate, has better structural strength and better adhering ability toward the surface of a tooth, and is designed to avoid the accumulation of food debris thereon.

2. Description of the Prior Art

Conventionally, various orthodontic braces (or brackets) are used for orthodontic purpose. The principle of orthodontics is to apply force produced from an arch wire to teeth for correcting alignment of teeth and their positions with regard to occlusion. Thereby, various flaws of teeth and jaws can be corrected.

With the popularization of orthodontics, various orthodontic braces emerge in the market correspondingly. Self-ligating orthodontic brackets are newer products. By using the self-ligating orthodontic brackets, the friction between the arch wire and the bracket is reduced while the feeling of soreness produced during orthodontic process is alleviated. Besides, the teeth can be aligned to desired positions faster and the orthodontic time can be shortened accordingly.

A conventional self-ligating orthodontic bracket usually comprises a body and a cover that is in pivatal connection with the body. The body is provided with a slot at one end of the top thereof for receiving an arch wire therein. Besides, the body is connected with a pad on the bottom thereof for adhering the body to the outer surface of a tooth. The cover engages with the body via a dovetail structure. For example, the cover is usually disposed with a digital protrusion at one end for engagement with a combed recess provided at the body Therefore, an arch wire can be positioned within the slot to perform orthodontic function.

However, during orthodontic process, there are still some crevices between the digital protrusion and the combed recess and food debris are easily accumulated within these crevices. With the accumulation of food debris in the crevices, bacteria will grow easily and rapidly and teeth will be affected consequently. Moreover, the accumulation of food debris will also affect the cover's normal opening and closing and thus results in abnormal performance of the orthodontic bracket.

Furthermore, when dovetail structure is used as the means for the engagement of the cover and the body, parts of the cover and the body involved in the engagement are usually structurally weakest. Accordingly, the cover is easily to be deformed during orthodontic process. Besides, a conventional self-ligating orthodontic bracket is usually formed from one piece. Owing to this design limitation, it is difficult to optimize the surface of the pad attaching to the outer surface of a tooth and the adhering ability of the conventional self-ligating orthodontic bracket is weakened.

In order to solve the problems mentioned above, inventor had the motive to study and develop the present invention after hard research to provide a self-ligating orthodontic bracket that is pleasing in appearance and easy to operate, has better structural strength and better adhering ability toward the surface of a tooth, and is designed to avoid the accumulation of food debris thereon.

### SUMMARY OF THE INVENTION

An object of the present invention is to provide a self-ligating orthodontic bracket with an internalized structure for engaging a main body with a cover to prevent food debris from being accumulated on the surface of the self-ligating orthodontic bracket.

Another object of the present invention is to provide a self-ligating orthodontic bracket having an engagement structure for connecting the main body with the cover, where the cover has better structural strength by the design of the engagement structure, so that the cover will not be deformed easily after a period of using.

Another object of the present invention is to provide a self-ligating orthodontic bracket, wherein the main body and the base are assembled after manufactured, so that the surface of the base attaching to the outer surface of a tooth can be optimized to strengthen the adhering ability thereof.

In order to achieve the above objects, the present invention provides a self-ligating orthodontic bracket comprising a main body and a base fixed to the bottom of the main body, where a slot is provided at one end of the top of the main body for receiving an arch wire therein and the self-ligating orthodontic bracket is adhered to an outer surface of a tooth via the bottom of the base and is characterized in that: the main body is in detachable connection with a cover, where:

the main body comprises a connecting part and at least an engaging part; the connecting part is located at one end near the slot and is provided with at least a track at two lateral sides respectively; the engaging part is provided at one end of the connecting part; the cover has two lateral sides that are in sliding connection with the tracks and is provided with at least a protrusion on its bottom for engagement with the engaging part.

In practice, the cover is preferably provided with two stop parts on the bottom of the cover's front end while two stop tracks for limiting the stop parts therein are provided respectively at locations near two lateral sides of the engaging part, so that the cover will not be detached from the main body.

The following detailed description, given by way of examples or embodiments, will best be understood in conjunction with the accompanying drawings.

### BRIEF DESCRIPTION OF THE DRAWINGS

FIG. 1 shows a perspective view of a self-ligating orthodontic bracket of the present invention, where a cover is closed.

FIG. 2 shows another perspective view of the self-ligating orthodontic bracket of the present invention, where the cover is open.

FIG. 3 shows a sectional view of FIG. 2 along aa′ line.

FIG. 4 shows another perspective view of the self-ligating orthodontic bracket of the present invention, where the cover is removed.

FIG. 5 shows a bottom view of the cover of the present invention.

FIG. 6 shows a bottom view of the self-ligating orthodontic bracket of the present invention.

FIG. 7 shows another perspective view of the self-ligating orthodontic bracket of the present invention, where an arch wire is received into a slot of the self-ligating orthodontic bracket.

FIG. 8 shows a sectional view of FIG. 7 along bb′ line.

FIG. 9 shows a using state diagram of the self-ligating orthodontic bracket of the present invention.

### DETAILED DESCRIPTION OF THE PREFERRED EMBODIMENTS

The present invention relates to a self-ligating orthodontic bracket 1 comprising a main body 10, a cover 12, and a base 14 connected to the bottom of the main body 10.

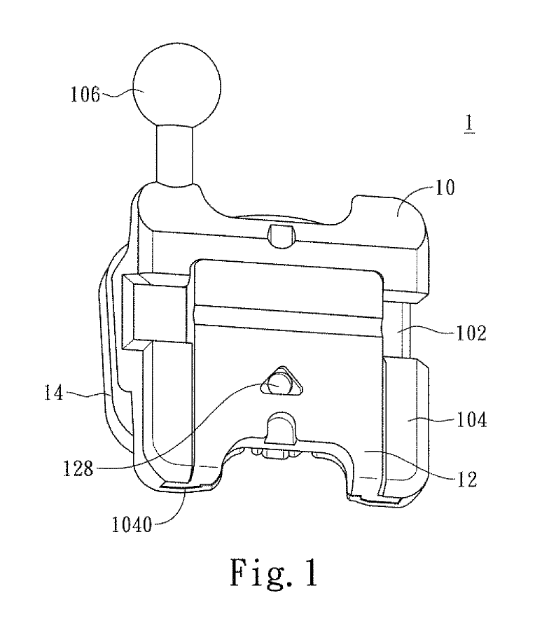

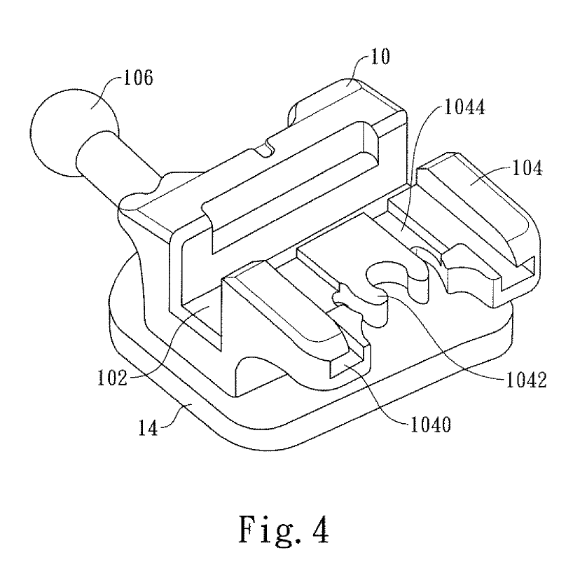

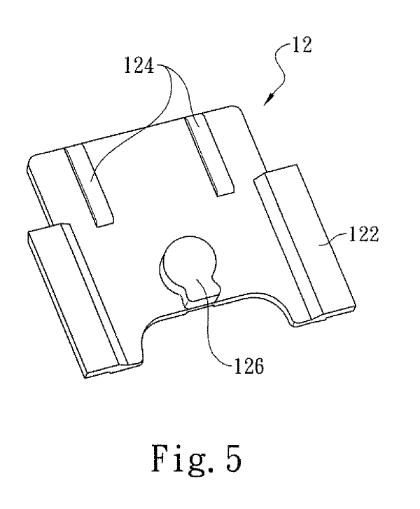

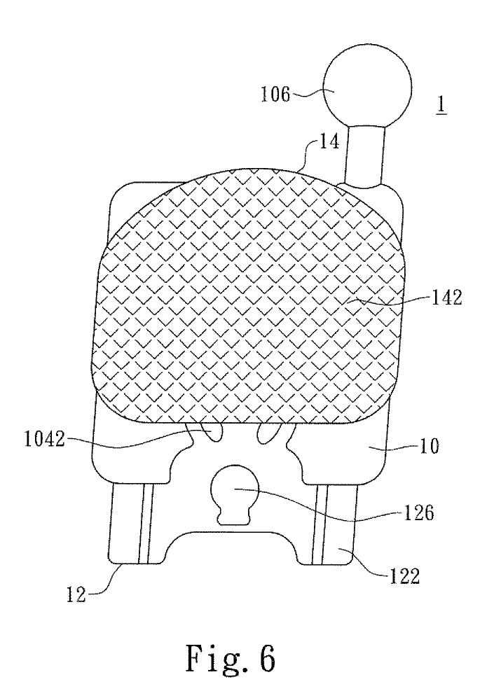

Please refer to FIGS. 1, 4, 5 and 6 of the present invention. As shown in above figures, the main body 10 is provided with a slot 102 at one end on the top thereof for receiving an arch wire in orthodontic purpose. Besides, the main body 10 has a connecting part 104 near the slot 102 and a hook 106 at the front end thereof. The connecting part 104 is provided respectively with a track 1040 at two lateral sides thereof and has an engaging part 1042 at one end on the top thereof Besides, a stop track 1044 is provided at each of the two locations adjacent to two lateral sides of the engaging part 1042.

The cover 12 includes two connections 122, two stop parts 124, a protrusion 126, and a recess 128 located on the top of the cover 12 The connections 122 are disposed at two lateral sides of the cover 12 respectively for movable connection with the tracks 1040. The stop parts 124 are disposed at one end on the bottom of the cover 12 for connection with the stop tracks 1044 of the main body 10. Part of the stop track 1044 near its opening is designed in L-shape and consequently the stop parts 124 can be limited within the stop tracks 1044 after the stop parts 124 are slid into the stop tracks 1044. Thereby, the cover 12 can be prevented from disconnection with the main body 10. The protrusion 106 is disposed on the bottom of the cover 12 for engagement with the engaging part 1042. The recess 128 is provided on the top of the cover 12 for users to move the cover 12 more conveniently.

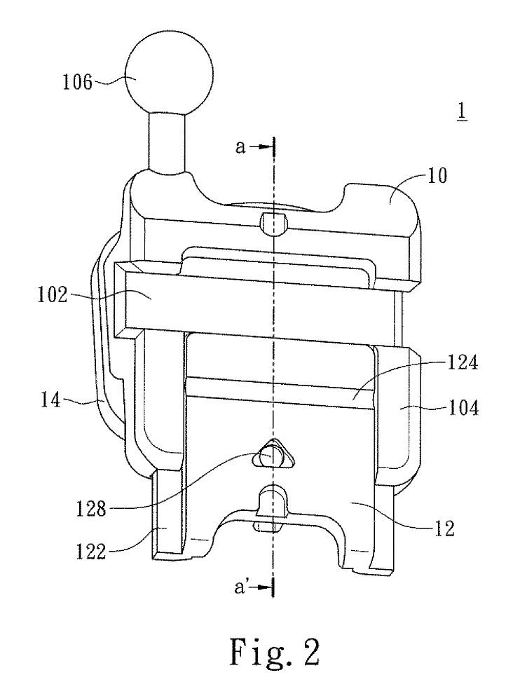

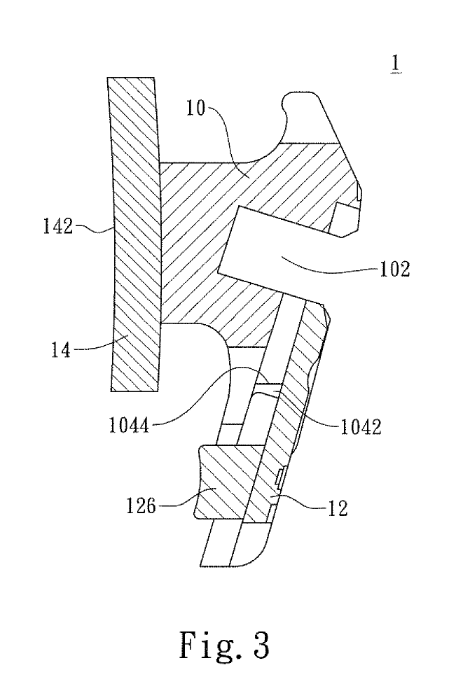

Please refer to FIGS. 2 and 3. As shown in these figures, because the stop pans 124 are limited within the stop tracks 1044 when the cover 12 is open, the cover 12 can be kept in connection with the body 10 without being disconnected therefrom.

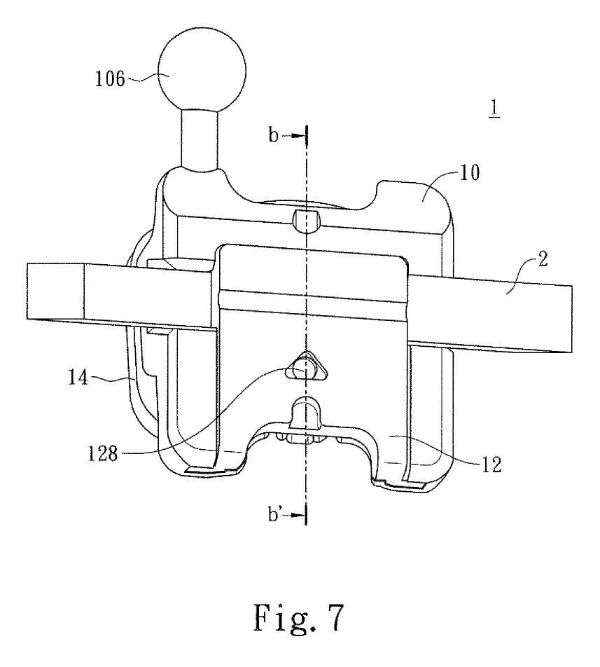

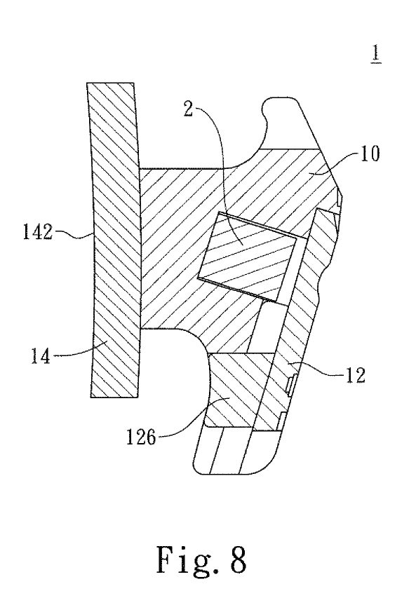

Please refer to FIGS. 7 and 8. When users intend to move the cover 12 to enclose the slot 102 of the main body 10, the cover 12 can be positioned over the slot 102 via the engagement of the protrusion 126 on the bottom of the cover 12 and the engaging part 1042 of the main body 10. Thereby, the arch wire can be restricted within the slot 102 of the main body 10.

Besides, the bottom surface 142 of the base 14 is processed as a surface with better adhering ability to the outer surface of a tooth.

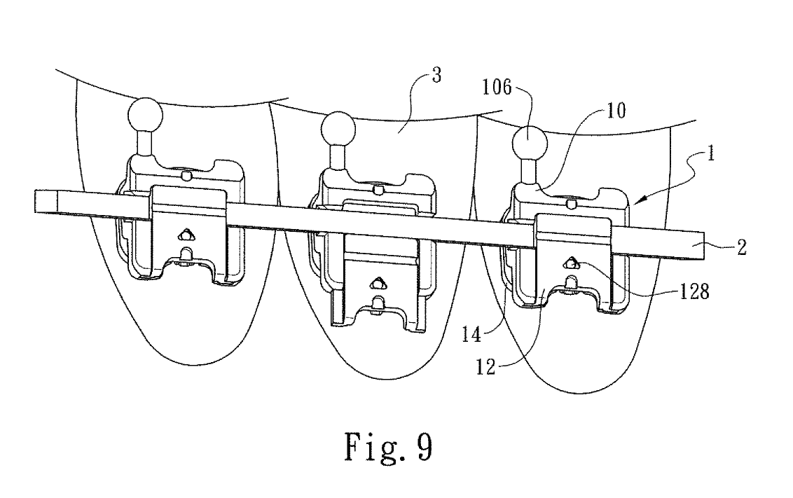

In practice, as shown in FIG. 9, when it needs to open the cover 12 for receiving an arch wire 2 into the slot 102 of the main body 10, dentists can utilize the tip of a suitable dental instrument to slide the cover 12 downward via the recess 128. After the arch wire 2 is placed into the slot 102, dentists can close the cover 12 to enclose the arch wire 2 within the slot 102 by using fingers to push the cover 12 upward to the location covering the slot 102.

Moreover, the hook 106 at the front end of the main body 10 is integrated with the main body 10 and used for correction of irregular teeth. The irregular teeth can be corrected by continuously applying force toward a certain direction to the hook 106 via suitable means. For example, elastic materials (such as springs or elastic rings) can be hanged on the hook 106 in order to provide the hook 106 with suitable force toward a desired direction.

The engagement structure for connecting the main body 10 with the cover 12 is internalized accordingly to the present invention. In other words, the engagement structure is hidden beneath the cover 12. Consequently, food debris can be prevented from being accumulated on the self-ligating orthodontic bracket 1. Besides, the cover 12 is provided with sufficient structural strength via the structural design of the engagement structure. Thereby, the cover 12 will not easily be deformed after a period of using.

Furthermore, according to the present invention, the base 14 and the main body 10 are manufactured separately and then assembled together. Thereby, the surface of the base attaching to the outer surface of a tooth can be optimized to strengthen the adhering ability toward the outer surface of a tooth.

In addition, the main body 10, the cover 12, and the base 14 can be made of metal or ceramic materials. Or, the cover 12 can be made of ceramic materials and consequently it can be colored with different hues to give the self-ligating orthodontic bracket 1 more pleasing appearance. Besides, the cover 12 can also be made of high molecular materials or composite materials.

Therefore, the present invention has the following advantages:
1. By hiding the engagement structure beneath the cover and between the main body and the cover, the accumulation of food debris on the surface of the self-ligating orthodontic bracket can be prevented and consequently the bacterial growth resulting from the accumulation of the food debris can be reduced correspondingly.
2. In practical operation, an arch wire can be put into or removed out of the slot more conveniently by means of the structural design of the cover.
3. The present invention can be provided with a more pleasing appearance by coloring the cover made of ceramic materials.
4. By providing the cover with better structural strength via the structural design of the engagement structure, the cover will not easily be deformed after a period of using.
5. The surface of the base attaching to the outer surface of a tooth can be optimized to strengthen the adhering ability of the self-ligating orthodontic bracket by manufacturing separately the main body and the base and assembling them after they are manufactured.

As disclosed in the above description and attached drawings, the present invention can provide a self-ligating orthodontic bracket, which is pleasing in appearance and easy to operate, has better structural strength and better adhering ability toward the outer surface of a tooth, and is designed to avoid the accumulation of food debris thereon. It is new and can be put into industrial use.

Although the embodiments of the present invention have been described in detail, various modifications and variations may be made by those skilled in the art from the teachings disclosed hereinabove. Therefore, it should be understood that any modification and variation equivalent to the spirit of the present invention be regarded to fall into the scope defined by the appended claims.

What is claimed is:

1. A self-ligating orthodontic bracket, comprising a main body and a base connected to the bottom of the main body, where a slot is provided at one end on the top of the main body for placing an arch wire therein and the self-ligating orthodontic bracket is adhered to an outer surface of a tooth via the bottom of the base and is characterized in that:
the main body is in detachable connection with a cover, where:
the main body comprises a connecting part and at least an engaging part; the connecting part is located at one end near the slot and is provided with at least a track at two lateral sides respectively; the engaging part is provided at one end of the connecting part;
the cover has two lateral sides that are in sliding connection with the tracks and is provided with at least a protrusion on its bottom for engagement with the engaging part.

2. The self-ligating orthodontic bracket as claimed in claim 1, wherein the cover is further provided with two stop parts on the bottom of the cover's front end while two stop tracks for limiting the stop parts therein are provided respectively at locations near two lateral sides of the engaging part to prevent the cover from disconnection with the main body.

3. The self-ligating orthodontic bracket as claimed in claim 1, wherein the cover is further provided with at least a recess on the top thereof.

4. The self-ligating orthodontic bracket as claimed in claim 1, wherein the bottom of the base is a surface having better adhering ability toward the outer surface of a tooth.

5. The self-ligating orthodontic bracket as claimed in claim 1, wherein the front end of the main body is further provided with a hook.

6. The self-ligating orthodontic bracket as claimed in claim 1 is made of metal.

7. The self-ligating orthodontic bracket as claimed in claim 1 is made of ceramic materials.

8. The self-ligating orthodontic bracket as claimed in claim 1, wherein the cover is made of ceramic materials.

9. The self-ligating orthodontic bracket as claimed in claim 1, wherein the cover is made of high molecular materials.

10. The self-ligating orthodontic bracket as claimed in claim 1, wherein the cover is made of composite materials.
